(19) United States
(12) Patent Application Publication
(10) Pub. No.: US 2013/0212430 A1
(43) Pub. Date: Aug. 15, 2013

(54) ELECTRONIC DEVICE WITH FIRMWARE RECOVERY FUNCTION AND METHOD FOR RECOVERING FIRMWARE

(71) Applicants: Lei DENG, Shenzhen City (CN); Wei-Min HE, Shenzhen City (CN)

(72) Inventors: Lei DENG, Shenzhen City (CN); Wei-Min HE, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/612,896

(22) Filed: Sep. 13, 2012

(30) Foreign Application Priority Data
Feb. 9, 2012 (CN) 201210028816.6

(51) Int. Cl. G06F 11/14

(52) U.S. Cl. 714/15; 714/E11.133

(57) ABSTRACT

An electronic device with firmware recovery function includes a connecting port to connect the electronic device to an external device and a BMC. The BMC includes a firmware memory storing firmware data of the BMC and a microprocessor. The microprocessor determines whether the BMC is able to execute the firmware data in the firmware memory, and determines whether a download command for downloading firmware data is received from the external device when the BMC is not able to execute the firmware data in the firmware memory. The microprocessor further reads the firmware data from the external device into a memory space of the microprocessor upon receiving the download command, and recovers the firmware data in the firmware memory by writing the firmware data from the memory space of the microprocessor into the firmware memory. A related method is also provided.

### BACKGROUND

1. Technical Field

The present disclosure relates to data recovery, and particularly, to an electronic device capable of recovering firmware and a method for recovering firmware.

2. Description of Related Art

A baseboard management controller (BMC) is a specialized service processor that monitors a physical state of a computing device, such as a computer, sever or other computing devices. The BMC is usually contained in a motherboard or main circuit board of the computing device to be monitored. A firmware of the BMC may be damaged due to various reasons. When the firmware of the BMC is damaged, firmware data of the BMC has to be rewritten into a firmware memory of the BMC to recover the firmware using a firmware recovery tool after the computing device is powered off. However, by this firmware recovery method, powering-off the computing device is needed, which is inconvenient.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with firmware recovery function, in accordance with an exemplary embodiment.

FIG. 2 is a flowchart of a method for recovering firmware, in accordance with an exemplary embodiment.

### DETAILED DESCRIPTION

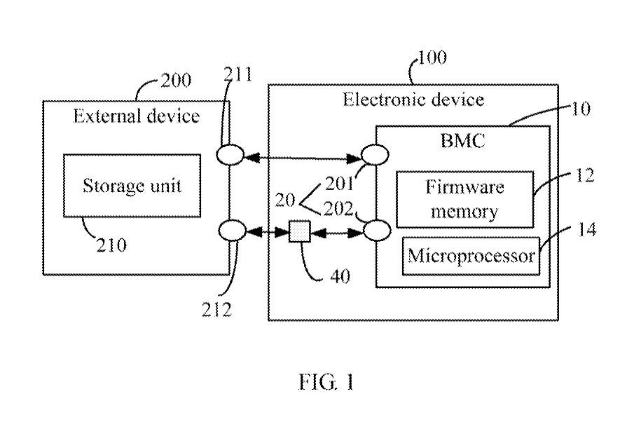

Referring to FIG. 1, an embodiment of an electronic device 100 with firmware recovery function is illustrated. The electronic device 100 includes a base management controller (BMC) 10. The BMC 10 includes a firmware memory 12 and a microprocessor 14 electrically connected to the firmware memory 12. The firmware memory 12 stores firmware data of the BMC 10. The firmware memory 12 may be, for example, a flash memory, a programmable read-only memory (PROM), or an electronically erasable programmable read-only memory (EPROM). If the firmware data of the BMC 10 is damaged, the BMC 10 cannot execute the firmware data to provide functions of the BMC 10.

The electronic device 100 further includes a connecting port 20 to electrically connect the electronic device 100 to an external device 200. The external device 200 includes a storage unit 210 storing firmware data of the BMC 10. If the firmware data in the firmware memory 12 is damaged, the electronic device 100 may recover the firmware data in the firmware memory 12 by using the firmware data in the storage unit 210. In this embodiment, when the electronic device 100 is connected to the external device 200, the microprocessor 14 may receive a download command for downloading firmware data from the external device 200. Upon receiving the download command from the external device 200, the microprocessor 14 reads the firmware data in the storage unit 210 into a memory space of the microprocessor 14. The microprocessor 14 may include a local addressable memory, such as a static random access memory (SRAM). The memory space may be a storage space of the addressable memory. The microprocessor 14 recovers the firmware data in the firmware memory 12 by writing the firmware data from the memory space of the microprocessor 14 into the firmware memory 12. After the firmware data in the firmware memory 12 is recovered, the microprocessor 14 reboots the BMC 10.

In this embodiment, the connecting port 20 includes a network interface card (NIC) 201 and a universal asynchronous receiver/transmitter (UART) 202. The NIC 201 is connected to the NIC 211 of the external device 200. The UART 202 is connected to the serial port 202 of the external device 200 via a serial chip 40. The download command from the external device 200 is transmitted to the microprocessor 14 through the serial port 212 and the UART 202. In other embodiments, the electronic device 100 may be connected to the external device 200 through a network, for example the Internet, and receives the download command through the network. The microprocessor 14 reads the firmware data in the storage unit 210 into the memory space of the microprocessor 14 through the network.

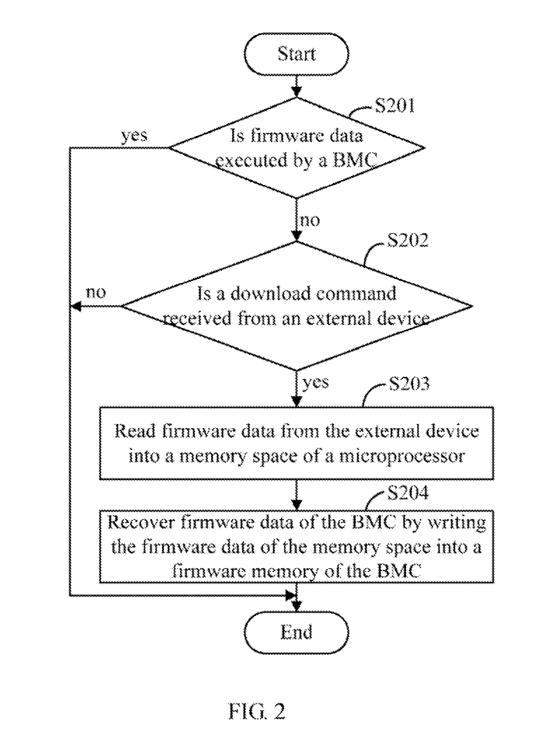

FIG. 2 is a method for recovering firmware in accordance with an exemplary embodiment.

In step S201, when the electronic device 100 is powered on, the microprocessor 14 determines whether the BMC 10 can execute the firmware data of the firmware memory 12. If yes, the procedure ends, otherwise, the procedure goes to step S202.

In step S202, the microprocessor 14 determines whether a download command for downloading firmware data is received from the external device 200. If yes, the procedure goes to step S203, otherwise, the procedure ends.

In step S203, the microprocessor 14 reads the firmware data from the external device 200 into the memory space of the microprocessor 14.

In step S204, the microprocessor 14 recovers the firmware data in the firmware memory 12 by writing the firmware data from the memory space of the microprocessor 14 into the firmware memory 12.

In step S205, the microprocessor 14 reboots the BMC 10 after the firmware data in the firmware memory 12 is recovered.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with firmware recovery function, comprising:
a connecting port to connect the electronic device to an external device; and
a base management controller (BMC) comprising a firmware memory and a microprocessor electrically connected to the firmware memory, the firmware memory storing firmware data of the BMC, the microprocessor being to determine whether the BMC is able to execute the firmware data in the firmware memory, and determine whether a download command for downloading firmware data is received from the external device when the BMC is not able to execute the firmware data in the firmware memory, the microprocessor being further to read the firmware data from the external device into a memory space of the microprocessor upon receiving the download command, and recover the firmware data in the firmware memory by writing the firmware data from the memory space of the microprocessor into the firmware memory.

2. The electronic device as described in claim 1, wherein the microprocessor is further to reboot the BMC when the firmware data in the firmware memory is recovered.

3. The electronic device as described in claim 1, wherein the connecting port comprises a network interface card (NIC) and a universal asynchronous receiver/transmitter (UART), the NIC of the connecting port is connected to an NIC of the external device, the UART is connected to a serial port of the external device via a serial chip, the download command from the external device is transmitted to the microprocessor through the serial port and the UART.

4. A method for recovering firmware applied in an electronic device, the electronic device comprising a connecting port and a base management controller (BMC), the connecting port being to connect the electronic device to an external device, the BMC comprising a firmware memory storing firmware data of the BMC and a microprocessor, the method comprising:
determining whether the BMC is able to execute the firmware data in the firmware memory via the microprocessor;
determining whether a download command for downloading firmware data is received from the external device when the BMC is not able to execute the firmware data in the firmware memory via the microprocessor;
reading the firmware data from the external device into a memory space of the microprocessor upon receiving the download command via the microprocessor; and
recovering the firmware data in the firmware memory by writing the firmware data from the memory space of the microprocessor into the firmware memory via the microprocessor.

5. The method as described in claim 4, further comprising:
rebooting the BMC after the firmware data in the firmware memory is recovered via the microprocessor.
